(19) United States
(12) Patent Application Publication
(10) Pub. No.: US 2001/0049653 A1
(43) Pub. Date: Dec. 6, 2001

(54) System for matching customers with products in inventory

(76) Inventor: Monty D. Sheets, Bedford, IN (US)

Correspondence Address: Russell E. Fowler, II, ICE MILLER DONADIO & RYAN, One American Square, Box 82001, Indianapolis, IN, 46282-0002, US

(21) Appl. No.: 09/746,096

(22) Filed: Dec. 21, 2000

Related U.S. Application Data
(60) Provisional application No. 60/171,387, filed on Dec. 22, 1999.

(51) Int. Cl. G06F 17/60

(52) U.S. Cl. 705/38; 705/20

(57) ABSTRACT

The present invention is a system for matching customers with products in inventory that will be desirable and affordable to the customers. The system features the ability to store information on multiple products in a product database and information on multiple customers in a customer database. The system then matches particular products in the product database with particular customers in the customer database based upon matching multiple search criteria fields associated with products and customers. The system also has the ability to generate net prices for each product (i.e., total price or total monthly payment amounts) based upon the qualifications of the particular customer, and limit the number of products matched with the particular customer based upon the customer's desired total payment or desired monthly payments. By generating reports that integrate customer/product matches with net price information, the system provides for effective and efficient shopping by customers.

### CROSS REFERENCE TO RELATED APPLICATIONS

This application claims the benefit of U.S. Provisional Application No. 60/171,387, filed Dec. 22, 1999.

### BACKGROUND OF THE INVENTION

Customers searching for automobiles at automobile dealerships and other car lots are often overwhelmed by the variety of choices. When the customer decides to look at cars without the help of a salesperson, it is sometimes difficult for the customer to determine if a particular car meets all of the customer's wants and needs. For example, a customer may require power locks, cruise control, or heated seats, but these features are not readily apparent by an exterior inspection of the automobile. In addition, customers wishing to finance their automobile purchases will sometimes waste time looking at a car they can not afford, because they can not determine what the monthly payments will be on the car by looking at the sticker price. If the customer wishes to shop efficiently, he or she must rely on the salesperson's knowledge of the automobiles in inventory and the salesperson's estimate of which cars will be affordable to the customer. If the customer is fortunate enough to receive assistance from an experienced salesperson with a good deal of knowledge about the cars on the lot, the salesperson may be of much help. However, a new and inexperienced salesperson with little knowledge about the cars on the lot will be of little assistance in helping the customer find a car that meets all of his or her requirements. Furthermore, even the most experienced salesperson will not be capable of estimating which cars are within a particular customer's price range because the net sales price or monthly payment of each car will vary from customer to customer based upon variables such as the customer's credit rating and eligibility for special manufacturer programs.

Some prior art systems have matched customers with cars of interest based on a comparison of the customer's desires with the features of the cars in inventory. These systems have been capable of generating reports which list the cars of interest along with features of each car of interest. In this manner, these prior art systems assist customers by pointing out particular cars that the customer may want to inspect, and thus make the shopping experience more efficient for the customer. However, these prior art systems have not provided immediate information to the customer on the net sales price or monthly payment amount (whether retail or lease) that the particular customer would pay for each car listed on the report. If a customer was interested in knowing the net sales price or monthly payment amount for a particular car on the report, the amount had to be calculated independently of the report. This process required a significant amount of time, especially if the customer was interested in knowing the net price or payment amount for a number of cars on the report.

Therefore, it would be advantageous to provide a system for selling automobiles that quickly and efficiently leads customers to affordable cars of interest. It would be advantageous if the system was capable of generating reports which not only matched customers with particular cars of interest but also integrated the net sales price or monthly payment amount (whether retail or lease) into the report. Thus, the customer would have all information required to make a car purchase immediately available on the system generated report, and the customer would only need to make a physical inspection of a particular car of interest before making a purchase decision.

### SUMMARY OF THE INVENTION

The present invention is a system for matching customers with products in inventory that will be desirable and affordable to the customers. The system features the ability to store information on multiple products in a product database and information on multiple customers in a customer database. The system then matches particular products in the product database with particular customers in the customer database based upon matching multiple search criteria fields associated with products and customers. The system also has the ability to generate net prices for each product (i.e., total price or total monthly payment amounts) based upon the qualifications of the particular customer, and limit the number of products matched with the particular customer based upon the customer's desired total payment or desired monthly payments. The system can handle desired monthly payments for both sale and lease of products. Calculation of the monthly payment includes all relevant factors including tax, finance rate, trade-in amounts, payoff amounts, rebates, and manufacturer incentives. Thus, the system is operable to match customers with products while simultaneously providing net prices for each product matched with a particular customer. By generating reports that integrate customer/product matches with net price information, the system provides for effective and efficient shopping by customers.

In addition to matching customers with products at provided net prices, the system is also capable of serving as a customer follow-up tool for pending customers who have yet to purchase a product. When a customer is entered into the system, certain information is stored in the system about the customer and his or her desires. When a product is acquired by the dealership and newly entered into the system, the system will generate a list of pending customers who may be interested in the product based upon customer desires already stored in the system. This action will assist in selling products by providing names of potential customers for products newly entered into inventory. Thus, the system is an excellent follow-up tool for sellers which ensures that pending customers are not forgotten when products meeting their needs becomes available.

The system is further capable of matching customers with products that are pending trade-ins. Pending trade-ins are products owned by other pending customers who have yet to purchase a product, but have a product which they are willing to trade in should they decide to make a purchase. The system keeps a file of pending trade-ins and, if a particular customer is not satisfied with the available choices from inventory, the system may match the customer with pending trade-ins that match the customer's desires. The owner of the pending trade-in is then contacted to determine if they are interested in selling the product to the present customer. By this action, the system offers another opportunity for the seller to meet the needs of the customer.

The system is also capable of generating advertising reports listing one or more particular products in inventory which match defined search criteria. The search criteria may include, but are not limited to, parameters such as product year, make, model, style, options, milage, net price, and net payments (retail or lease). Net prices and net payments for the products are generated by first using general system defaults to calculate a gross price, such as prescribing each product's price as a set dollar amount or set percentage over the product's actual cash value, sticker price, invoice or other value. Other defaults are then used in calculating net prices and/or payments, including general default amounts for rebates available, manufacturer incentives, cash down payment, interest rates, and financing or lease term. The output format of the report is specified so that the report may be immediately used for advertising purposes. For example, in addition to listing the information on the product required by the various search parameters such as product make, model and net price, the report may also list other information stored by the system about the product such as available options.

### BRIEF DESCRIPTION OF THE DRAWINGS

FIG. 1 is a block diagram of the system for matching customers with products in inventory.

FIG. 2 flow chart showing a method for selling products using the system of FIG. 1;

FIG. 3 shows an exemplary computer screen showing data entry a deal record of the system of FIG. 1;

FIG. 4 shows an exemplary computer screen of a vehicles available report generated by the system of FIG. 1;

FIG. 5 shows an exemplary computer screen of a potential deals report generated by the system of FIG. 1.

### DETAILED DESCRIPTION

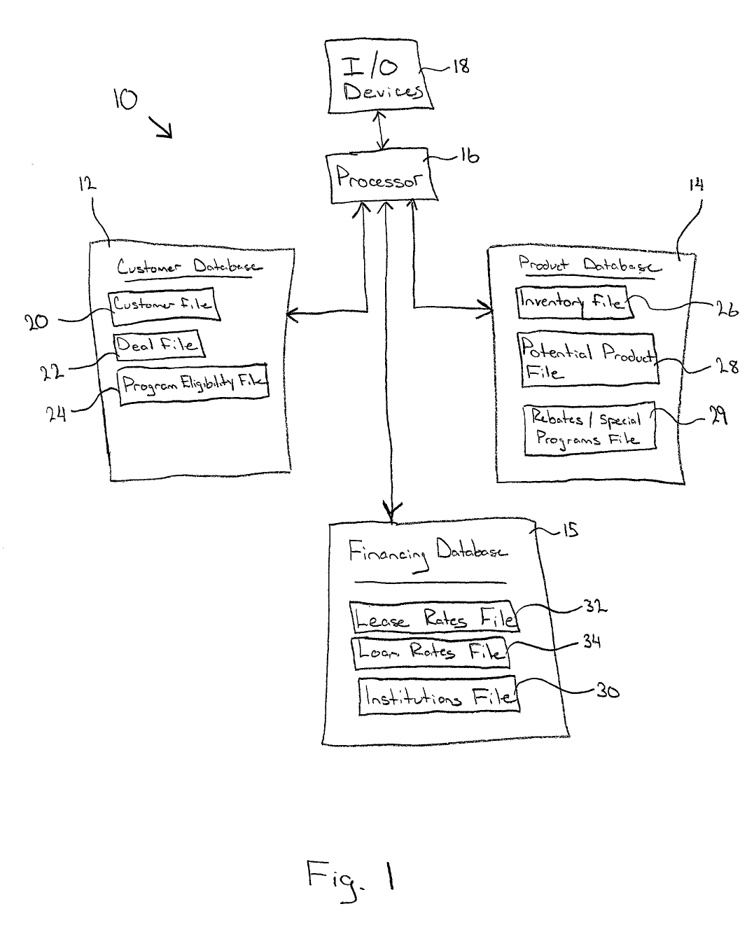

As shown in FIG. 1, the present invention is a computerized system 10 for selling automobiles or similar products. The system 10 comprises a microprocessor 16 in communication with a customer database 12, a product database 14, a financing database 15 and input/output devices 18. The system 10 has the ability to produce reports which match particular customers with particular products by comparing information in the customer database 12 with information in the product database 14 and financing database 15. Based upon the reports generated by the system 10, customers are empowered to find automobiles suiting their needs in a faster, more efficient manner when they visit a dealership or other car lot to purchase an automobile.

A human operator known as the “desk manager” or “system operator” is used to input data into the system and request output of data and reports from the system 10 through the input/output devices 18. The input/output devices 18 generally include computer display screens, printers, speakers, keyboards, mice and other media for inputting information into a computer and receiving output from a computer. The processor 16 is generally a PENTIUM® quality or better chip in bidirectional communication with the input/output devices 18. The processor 16 is also in bidirectional communication with the customer database 12, product database 14, and financing database 15. The customer database 12, product database 14 and financing database 15 will generally reside on magnetic media, such as a computer hard drive. The customer database, product database and financing database may reside within the same desktop computer as the processor 16, or may be connected to the processor through a network. It will be recognized by those of skill in the art that any number of software environments may be used by the processor to implement the invention, including LINUX® and WINDOWS 98®.

The customer database 12 includes a customer file 20, a deal file 22, and a program eligibility file 24. The customer file 20 includes customer records for multiple customers who have visited the dealership looking for an automobile. Each customer record contains information about the customer's identity, including customer fields containing identifying information such as customer name, address, phone number, and any co-buyer. The customer file 20 also contains a customer number assigned to the particular customer by the system.

Information about the customer's desired purchase is stored in a deal record of the deal file 22. Each deal record in the deal file includes deal fields containing information on the particular customer and salesperson involved with the particular deal, such as the customer number and salesperson code. In addition, each record in the deal file includes deal fields containing information about the specific product interests of the customer, such as desired car make, desired car model, desired car year, desired color, desired options, etc. Some financial information is also stored in each deal file record such as desired total price or payment range, desired finance or lease term, credit rating, trade-in value, trade-in payoff amount, cash down payment, residual amounts, etc. Some information to be stored in the deal record may not be readily ascertainable from the customer. For example, the customer's credit rating will be requested from the credit bureau and entered into the deal record to help determine an interest rate for the particular customer. Also, an appraiser from the dealership will need to determine the trade in value of the customer's car before the trade-in value may be entered into the deal record. The records in the deal file also contain a field that indicates if the deal is “open” or “closed” and the date of the customer's last visit to the dealership concerning the particular deal. Deal records remain “open” for an indefinite amount of time. Records in the deal file are only “closed” when the customer purchases a product from the dealership or the salesperson determines that the customer is no longer interested in purchasing a product from the dealership. If a customer returns to the dealership after his deal record is closed, a new deal record is simply opened and the customer record is updated with the customer's most recent information. If a particular customer is interested in purchasing more than one automobile, a separate deal record is opened for each desired purchase.

Information on desired products and options in each deal record may be prioritized by the customer's desires as “high priority,” “low priority” or “no priority.” For example, a customer may specify that he must have a General Motors sedan with air conditioning and a monthly payment of less than $250 per month, and these are “high priority” items. He may further state that he prefers a red car with less than 50,000 miles, but these are “low priority” items. The customer may then declare that all other options are irrelevant or “no priority”. When the system operator enters the customer's information into the deal record, these priorities will be noted so that the automobiles most closely matching the customer's prioritized needs are retrieved when the system performs a search for the customer, as will be explained in more detail.

The program eligibility file 24 contains information about each customer's eligibility for special manufacturer purchase programs. For example, employees of Chrysler Corporation may be entitled to special discounts for new Chrysler products. The program eligibility file 24 contains records having a customer identifier field (e.g., customer number) and other fields which indicate whether the customer is eligible for any special purchase programs. It is possible for a buyer to be eligible for special purchase programs from more than one manufacturer, and each special program for which the customer is eligible is stored in the program eligibility file.

The product database 14 includes an inventory file 26, a potential product file 28, and a rebates/special programs file 29. The inventory file 24 includes records of information on all automobiles being offered for sale by the dealership. Each record in the inventory file 26 contains specific identifying data or information on each vehicle. For example, each record within the inventory file 26 may contain the following product fields: product year, product manufacturer, product make, product size, product model, product type, product style, product color, product options, product miles/hours, product stock number, sticker price, invoice amount, and actual cash value. Automobiles already purchased by a customer or sold out of inventory to other dealers must be noted as such in the inventory file to prevent the system from matching customers with already purchased products. Thus, the records in the inventory file 26 also include a field that indicates whether the product remains available for customer purchase.

The product database 14 also contains information on other automobiles, such as automobiles that pending customers hold as potential trade-ins. These records are stored in the potential product file 28, which is sometimes referred to as the “trade-ins file”. The records stored in the potential products file 28 contain, but are not limited to, the following fields: product year, product manufacturer, product make, product size, product model, product type, product style, product color, product options, product miles/hours, product price range, and customer identification number. If a pending customer with a trade-in purchases a car using the trade-in, the customer's trade-in record will be automatically converted from a record in the potential product file 28 to a record in the inventory file 26. Thus, when a deal is started, potential trade-in vehicles are placed in the potential products file, and at the close of a deal, trade-in vehicles are moved to the inventory file.

The product database 14 further includes a rebates/special programs file 29. This file contains all information on rebates for specific products and special purchase programs offered to eligible individuals, including specific discount amounts and effective dates of the rebates and special purchase programs. When the system goes to calculate a total price or payment for any particular product in the product database, the system will check the rebates/special programs file 29 to see if any discounts apply to the price of the product.

In addition to the customer database 12 and the product database 14, the system also includes a financing database 15. The financing database includes an institutions file 30 which stores identification information on various lending institutions including banks, credit unions, and corporate lending institutions (e.g., General Motors) which offer their services to the dealership. A loan rates file 34 and a lease rates file 32 is also maintained. The loan rates file 34 and lease rates file 32 keep records of various loan rates and lease rates offered by the financial institutions in the institutions file 30 to automobile customers. Various lease rates and loan rates will generally apply to different customers depending upon their credit status. Lease rates and loan rates may also vary depending upon the year of the vehicle and the term of the loan on the vehicle. In one embodiment of the invention, the lease rates file 32 could be removed and both loan and lease rates could be stored in the loan rates file 34. To this end, the term “loan rates” as used herein may include both loan and lease terms.

All information stored in the customer database 12, product database 14, and financial database 15 is periodically updated by the system operator to reflect the most current set of information for products and customers. For example, if a customer decides that he is more interested in a blue car than a red car, the system operator may enter the deal file and change the desired car color of the customer from red to blue. Further, if the price of a particular automobile on the dealership lot changes, such as a year-end reduction in price, the price of the automobile in the inventory file may be changed. In addition to making modifications, new records may be created in any of the files 20-34 the system operator at any time. For example, new records are created in the inventory file 26 as new products are received at the dealership. In this manner, the system operator may continually update information in the customer database and product database to allow for the best matches of customers and products. Some of the files may lend themselves to automatic updating via a networked system, such as the Internet or an intra-net. For example, the lease rates file 32 and loan rates file 34 may be automatically updated by the system on a daily basis by logging on to designated websites and downloading loan and lease rate information into the file.

With information stored in the customer database 12, the product database 14, and the financial database, the system 10 is operable to match a particular customer with particular automobiles that may fit the customer's individual desires and needs. To accomplish this, the system operator simply inputs a particular customer identifier into the system, such as the customer name or identification number, and requests the system to generate a report of products from the inventory file in which the customer may be interested. This type of report is referred to as a “vehicles available report.” With a customer identifier, such as a customer identification number, entered by the system operator, the processor 16 recovers the open record in the deal file 22 (i.e., the deal record) that is associated with the particular customer and performs a search of the product database inventory file 26 to determine which products most closely match the information stored in the deal record. If more than one record is open for the customer in the deal file 22, the system will prompt the system operator to choose which deal record the search is for.

As mentioned previously, the system operator can prioritize the information in the deal record so that the processor 16 finds the most relevant products for the customer and prints the records out in the vehicles available report. Thus, if the deal record specifies that a particular product make, product style, product price range, and particular product options (e.g., air-conditioning) are high priority fields for a particular customer, the processor 16 will primarily search for products in the inventory file 26 which match these high priority fields. After finding these products, the system will rank the products based on any low priority fields in the deal record. For example, a customer may specify that his high priority options are General Motors sedan-type vehicles with air-conditioning, less than 50,000 miles and priced less than $10,000 dollars; the customers may further specify that his low priority options are red automobiles with cd player, leather upholstery, and automatic windows. If a search is run for this customer all GM sedans with AC, less than 50,000 miles and priced less than $10,000 (the high priority items) will be returned from the search in the vehicles available report. The vehicles available report will rank the results by placing all the red automobiles with cd player, leather upholstery and automatic windows (the low priority items) at the top of the list of automobiles in the vehicles available report. Products missing only one of the low priority items will be next on the list, followed by products missing two of the low priority items, and so on. At the bottom of the list would be all products containing each of the high priority items, but none of the low priority items. In addition to prioritizing the vehicles available report, the system operator may limit the number of vehicles returned by the report (e.g., list a maximum of 10 vehicles).

Offered prices for automobiles may vary from customer to customer, depending upon the customer price factors, including but not limited to, trade-in value, customer's eligibility for special manufacturer programs and, if financing is requested, the customer's eligibility for certain interest rates and the customer's desired loan term. These customer price factors are stored in various fields of the customer database 12. If the customer specifies a range for the net sales price, the system first looks through the inventory file for products matching the other specified parameters. Then, after coming up with a group of matching vehicles, the system determines if, after rebates, special purchase program discounts, trade-in value, taxes owed, and any other factors, the net selling price for each vehicle will be within the specified price range. In order to determine a net selling price, the system first calculates a gross price for the vehicle based on general system defaults. For example, the gross price of a vehicle may be calculated as a set dollar amount or set percentage over the product's actual cash value, sticker price, invoice or other value. After the gross price is calculated, other factors particular to the customer are taken from the system and used to calculate net prices and/or payments. Examples of these other factors include amounts for rebates available, manufacturer incentives, cash down payment, interest rates, and financing or lease term. Finally, after calculating the net price for the vehicles, the products are listed in the vehicles available report if the products meet the specified price range requirements.

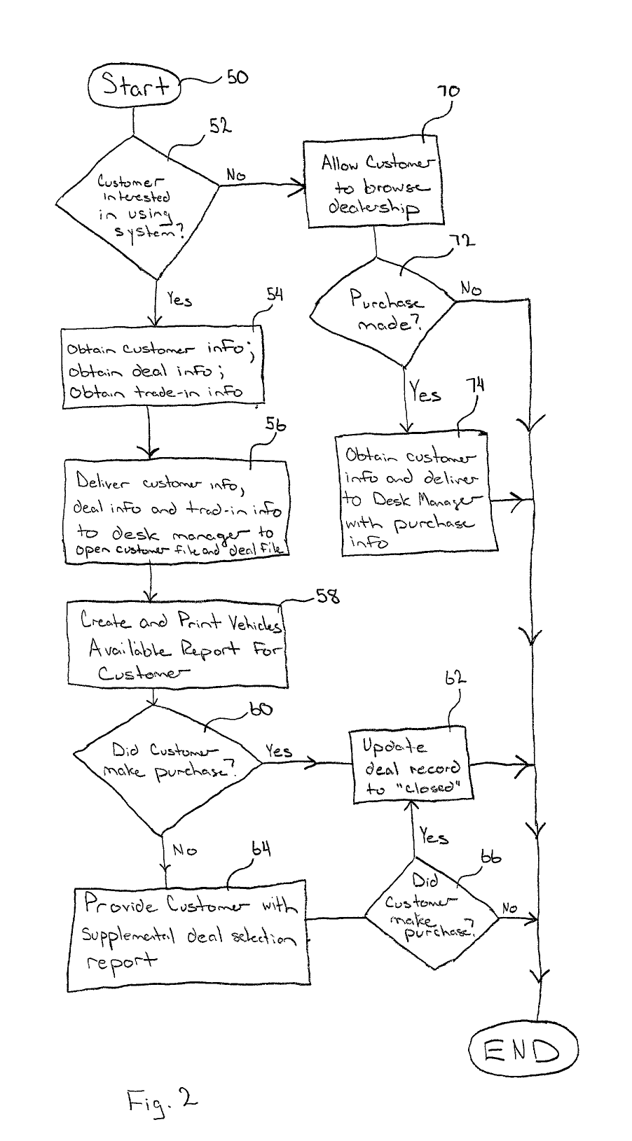

Operation of the system and a method for selling products using the system is now described with reference to FIG. 2. When a customer enters the automobile dealership, a salesperson greets the customer and offers assistance. This is the start of the sales process, as represented by step 50. During this initial encounter, the salesperson introduces the system 10 to the customer and describes the advantages of the system to the customer. To promote the system, a visual aid may be used by the salesperson such as a system brochure or video demonstration showing step-by-step examples of how the system works. The salesperson describes the system as a computerized tool for matching customers with particular products in inventory based upon the customer's individual needs. In particular, the system has the ability to provide the customer with a list of potential automobiles having features desired by the customer that are within the customer's price range. The list includes automobiles that the customer may be interested in based upon the customer's desired monthly payments. The system has the advantage of saving the customer and the dealership a great deal of time by directing the customer to specific automobiles on the lot that the customer is likely to be interested in and avoiding situations where the customer is interested in a specific car which he or she can not afford.

After the salesperson explains the system to the customer, the customer decides in step 52 if he or she is interested in using the system. If the customer is interested in using the system, the salesperson sits down with the customer, as shown by step 54, and obtains information about the customer, including name, address, phone number, and any other information required to create a customer record in the customer file 20. Next, the salesperson obtains sufficient information about the customer's desired purchase to complete a deal record for the customer for storage in the deal file 22. A standard form may be created by the dealership to remind the salesperson all of the information required or useful in creating customer records and deal records, including information about automobile options and financial constraints. The salesperson is also responsible for determining if the customer is eligible for any special manufacturer purchase programs so the information can be stored in the program eligibility file 24.

In addition to customer information, deal information and program eligibility, the salesperson must also determine if the customer has a trade-in vehicle to offer in the deal. If so, information on the trade-in vehicle must also be obtained from the customer. In general, the same information is collected from the customer about a potential trade-in as would be collected and stored in the inventory file for existing dealership automobiles. In order to determine the trade-in value of the vehicle, the salesperson must ask an appraiser employed by the dealership to inspect the customer's potential trade-in and place a value on the trade-in. Finally, if the salesperson must determine if the customer is interested in financing a vehicle and make a note of this.

Once all of the relevant information is obtained from the customer, the salesperson delivers the information to a system operator or “desk manager” responsible for entry of data into the system and generation of reports, as shown by step 56. If the customer is a new customer, the system operator creates a new record of the customer and stores the record in the customer file 20. The system operator then creates a new deal record based upon the information provided by the customer and this record is stored in the deal file. If the customer is interested in financing a vehicle, the desk manager may contact the credit bureau to obtain a credit report on the customer. The customer's credit status is obtained as a credit score. Monthly loan or lease payments will vary from customer to customer based upon the customer's credit score, as customers with poor credit will generally pay higher interest rates than customers with good credit.

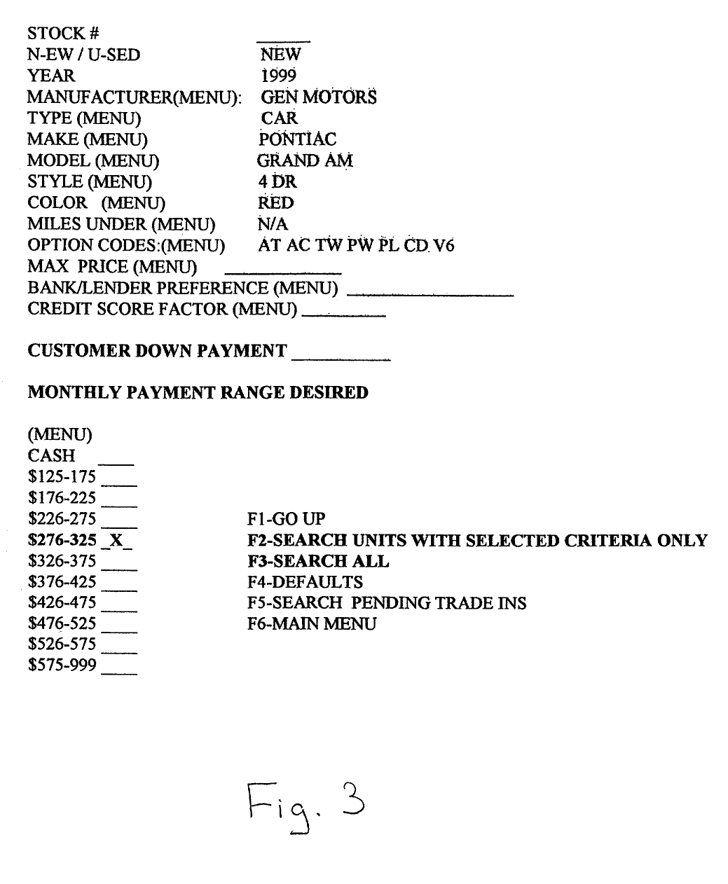

An exemplary computer screen showing data entry into a deal record is shown in FIG. 3. In this example, the customer is looking for a new red 1999 GM Pontiac Grand Am with four doors, automatic transmission, air-conditioning, tilt wheel, power windows, power locks, cd player, and a V6 engine. The customer is not concerned about the milage of the car, and accordingly, an “N/A” has been entered in the “miles under” field. The customer's credit status has yet to be entered, but is it shown that the customer wishes for his monthly payments to be in the range of $300.

After completing the deal record, the system operator moves on to complete a program eligibility record for the customer which is stored in the program eligibility file 24. The program eligibility record contains data fields that describe the customer's eligibility for any special manufacturer programs. Finally, the system operator creates a new potential product record based upon the customer's trade-in vehicle for storing in the potential product file 28.

After the system operator creates the appropriate records for the customer, the system operator requests the system to perform a search based upon the deal record for the customer and make a “vehicles available report”, as shown by step 58. The vehicles available report is generated by the system by matching field entries in the deal record with field entries in the inventory records. As described previously, the results of the search will depend upon the priorities of particular fields in the deal record. Also, the number of matching records generated by the report may be limited to a predetermined number to avoid a customer match report that is too large for the customer to use efficiently. For example, if a particular search would result in 100 matches, the search may be limited to the top ten matches to provide the customer with a workable list of automobiles which he or she may inspect in a single visit to the dealership.

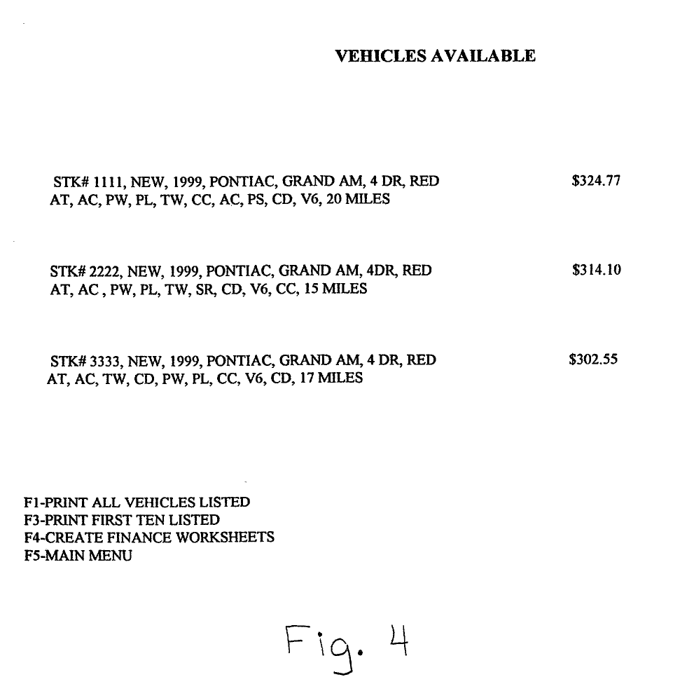

An exemplary vehicles available report is shown in FIG. 4. In this example, three red 1999 Pontiac Grand Am automobiles are listed meeting all of the customer's specifications. The monthly retail and lease payments for each vehicle, based upon lending rates available to the particular customer, are listed on the far right side of the report for each of the three vehicles. Each listed monthly payment is within the customer's acceptable range of monthly payments. A monthly lease rate is not shown for the final vehicle because the vehicle is either not available for lease, or the vehicle lease rate is outside of the customer's desired payment range.

An important factor in matching customers with products and creating a vehicles available report will generally be the customer's desired price or payment range. The system has the ability to calculate monthly payments and/or lease payments on any product in inventory by using calculations based on multiple pre set defaults. In other words, the system has the ability to calculate variables such as the tax, rebates, and program eligibility discounts and determine a monthly payment for each automobile in inventory based on the automobiles gross sales price and the customer's down payment, trade-in value, and available credit rate. After making these calculations, the system can determine which automobiles the customer may be interested in based on price, payment range, and other factors specified by the customer such as make, model, year, color, etc. Of course, the seller retains the flexibility to reduce the sales price of a particular product in inventory to bring the product within a particular customer's maximum total payment or maximum monthly payment range.

After the vehicles available report is generated by the system, it is printed out and delivered to the customer, as represented by step 58. The customer then inspects the vehicles generated by the report and decides whether he or she is interested in purchasing one of the vehicles. If the customer makes a purchase, as shown in step 60, the customer's information is updated in the system, as shown in step 62. Specifically, the deal record is updated from “open” to “closed” and the customer's trade-in is transferred from the potential product file to the inventory file.

As shown by step 64, if the customer decides that none of the products listed on the vehicles available report are acceptable to the customer, a second vehicles available search is run for the customer which delivers a list of matches between the deal file and the potential products file. This search is generally limited to products entered into the potential products file after a given cut-off date. This prevents the system from searching for vehicles that have been in the system for so long that the listed owners have probably already sold the vehicles. After a search report is printed out, the customer is asked to review the list of potential trade-in vehicles from the potential products file and determine if he or she is interested in any of the vehicles. If the customer is interested in looking at one or more of the vehicles, the owner of the vehicle is contacted to determine if he or she is still interested in trading the vehicle to the dealership or selling the vehicle to the present customer. If the vehicle owner is still interested in such a transaction, an appointment is made to allow the present customer to inspect the vehicle. If, after viewing the vehicle, the customer decides that he or she wishes to purchase the vehicle, multiple simultaneous sales may be negotiated, with the trade-in from one deal being pre-sold in the other deal. This situation results in a three-way deal between the vehicle owner, the customer and the dealership. Alternatively, a direct deal may be arranged between the customer and the vehicle owner and the dealership may take a percentage of the selling price of the vehicle as a commission for introducing the buyer to the seller.

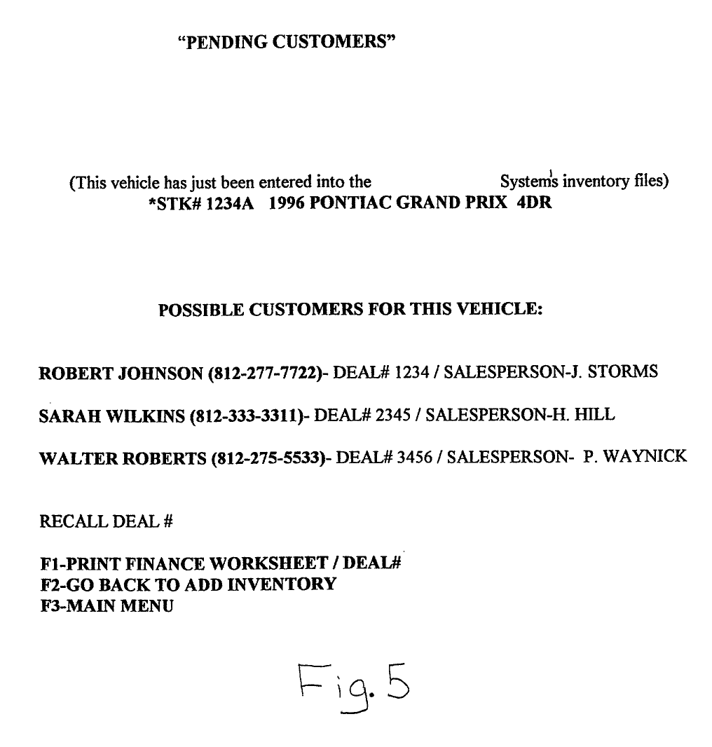

As shown in step 66, if the customer's initial use of the system does not result in any vehicles which the customer is interested in, the customer's deal record remains “open or “pending” in the customer database deal file 22. Thereafter, when a new product is added to the inventory file 26, a “potential deals report” is printed to list any “pending” or “open” deals with associated customers that may be interested in the new product. This report is then delivered to the appropriate salesperson responsible for one of the open deal so that the potential customers may be contacted about the new product. An example of such a report is shown in FIG. 5. The potential deals report includes a description of the new product, the potential customer's name, telephone number and deal number, and the salesperson who assisted the customer. The potential deals report shown in FIG. 5 is for a 1996 Pontiac Grand Prix recently obtained by the dealership and entered into the inventory file. Three potential customers are listed in the report who might be interested in the Grand Prix, based upon information previously provided by the customer. This feature provides an extremely important follow up tool ensuring that pending customers are not forgotten when additional products matching their search parameters become available.

In an alternative embodiment of the invention, the product database may contain an additional file containing information on automobiles located at sister dealerships. In this embodiment, a separate report may be printed out to inform the customer of automobiles which the customer may want to inspect at the sister dealership if the customer is not satisfied with his or her choice of automobiles at the visited dealership.

With reference again to FIG. 2, It is envisioned that not all customers will want to use the system upon entering the dealership, and will simply wish to browse the lot for automobiles. If this is the situation, the salesperson does not attempt to obtain customer information from the customer immediately, but allows the customer to browse for automobiles in a conventional fashion, as shown in step 70. If the customer finds a car that he or she likes and makes a purchase in step 72, customer information will be entered into the system in step 74 to provide the dealership with a record of the customer's purchases. In this manner, valuable information will be available should the customer return in the future to buy another automobile from the dealership.

The above-described system provides the opportunity for a dealer to offer a completely hassle free sales system for customers. According to the sales system, customers simply tell the dealership representatives what they are looking for, and the price or payment range they desire. The system will locate any vehicles matching the customer's vehicle desires and payment range and generate a list of vehicles in which the customer may be interested. The list is given to the customer, allowing the customer to freely inspect the vehicles that match the customer's desired criteria and payment range without any salesperson pressures.

### Automobile Sales Example

The following is an example of the system in operation:

A gentleman arrives at a dealership looking for a used automobile. He tells the sales representative he is looking for a nice four door, mid sized vehicle, with an automatic transmission, air conditioning, and a CD player. He tells the sales representative he would like to trade in his vehicle, and his trade in has an approximate payoff of about $2000 still owed on it. The customer also states he has a total of $500 to use for a down payment, and he wants to purchase a vehicle that will keep his payments under $300 a month.

The sales representative has an appraiser evaluate the trade in, and place a trade value on the vehicle. Following the appraisal of the vehicle, the value of the vehicle is given to the desk manager along with all other information collected by the sales representative about the customer.

The desk manager enters the customer's identification information into the system along with the customer's vehicle desires, trade-in value, and any other information. Other information may include financial information if the customer is interested in financing a vehicle. If this is the case, the desk manager may contact the credit bureau and pull the customer's credit record to determine a current credit rating for the customer for entry into the system. By entering all of the customer's information into the system, the desk manager creates a customer record, a deal record, a program eligibility record, and a potential trade-in record for the customer.

After entering all relevant information into the system, the desk manager runs a vehicle availability report for the customer, causing the system to compare the deal record created for the customer with the stored information on all vehicles in the dealerships inventory and produce a list of available vehicles at the dealership which most closely match the customer's desires within the $300 per month payment range. The vehicle availability report is given to the sales representative who shows the customer all of the available vehicles most closely matching the customer's desires.

If the customer shows an interest in a vehicle, the sales representative gives a product presentation on the vehicle selected, and offers the customer a test drive. After returning from the test drive, if the customer decides that the vehicle is what he wants, the desk manager provides the sales representative with a system generated worksheet showing all figures the system produced to calculate the vehicle. Finally, the sales representative takes the figures to the business manager, where the final paperwork is finished, and the deal is consummated.

If the customer does not find a vehicle he is interested in, the system is asked to search the potential product file for trade-in vehicles from pending customers that may still be available. If a pending trade-in is something that may work, the dealer representative calls the previous customer to see if that customer is still willing to trade the vehicle in, or simply sell the vehicle to the dealership. If the previous customer is willing to do this, a meeting is arranged for the new customer to inspect the previous customer's vehicle. If the new customer is interested, a deal is struck between the dealership, the new customer, and the previous customer.

If there are no pending trade in vehicles available matching the customers search criteria, and no deal is reached, the deal record is simply stored in the deal files as an open deal. When a new vehicle is entered into the system, a “potential deals report” is automatically generated by the system to produce a list of customers who might be interested in the newly entered vehicle. The desk manager prints out the “potential deals report” and delivers a copy of it to the sales representatives responsible for each potential customer on the report. The sales representatives then make follow-up calls to the potential customers they are responsible for to inform the customers about the new product in the dealership's inventory.

In addition to the operations described above, the system is also capable of producing different types of reports for use by the dealership. Preparation of reports is a time-consuming process for all dealerships, and the present invention offers a substantial reduction in the time required to generate these reports. For example, advertising reports may be generated by the system 10 which list products to be advertised based on selected product requirements, such as monthly payment (retail or lease) and/or net selling prices which are calculated using standard or “default” down payments, trade-ins, rebates, manufacturer incentives, and other values. The fact that the system may be used for other purposes than selling automobiles provides an additional selling point for the system. Examples of reports that may be generated by the system include the following:

1. CUSTOMER DATABASE REPORT: This report is a list of all customers (sold and/or pending) which have been entered into the system. Some fields printed may include but are not limited to name, address, city, state, zip, telephone number). Output of these reports may be on a printer, or may be used to merge with other files for automatic e-mailing of special offers. These reports may also be e-mailed or electronically transferred to a print shop for generating sales materials with preprinted customer addresses.

2. INVENTORY REPORT—This report lists all products in inventory. For automobile product types, fields may include but are not limited to model year, make, model, style, mileage, vehicle identification number, color, stock number, options, and number of days in inventory. The list of products generated by the report may be sorted by a number of different categories, including product age in inventory and model year.

3. ADVERTISING INVENTORY REPORT—This report provides a list of products by defined information fields such as make, model, and year. Information included on this report may include net selling price and/or monthly payments (lease or loan) along with product options such as air-conditioning and cruise control.

4. NEW AND/OR USED INVENTORY ANALYSIS REPORT—This report shows the total number and percentage of products sold in a certain category for a range of dates. For example, reports may show the total number of used vehicles sold in calendar year 1999. Other reports may be defined to show vehicles sold based on manufacturer, year, make, model, options, color, mileage, price range, and average number of days in inventory, etc.

5. SALESPERSON REPORT—This report provides information related to each salesperson at the dealership, including number of customers or deals entered into the system, number of deals sold, closing ratio percentage, ratio of new to used vehicles sold, ratio of retail to leased vehicles, and list of “pending deals” for each salesperson.

6. RETAIL AND MANUFACTURER PROGRAM REPORT—This report shows the number of retail deals and the number of deals involving manufacturer special purchase programs. The number of retail deals to special purchase programs may be expressed as a percentage or a ratio.

7. PENDING CUSTOMER REPORT—This report is a list of “pending” or “open” deals where the customer has yet to purchase an automobile.

8. LENDER REPORT—This report lists all lenders along with customer preferences for lenders by total numbers of customers requesting a particular lender and percentage of customers requesting the particular lender.

9. CITY/ZIP CODE REPORT—This report provides a list of all cities and/or zip codes where dealership customers are located.

10. DAY/MONTH ANALYSIS REPORT—This report is capable of listing the total number of a particular type of product or product characteristic that is sold during a certain period of time. For example, this report could list the percentage of red cars that are sold in January compared to the rest of the year. This report could also list the day of the week in which the most cars were sold for a particular year. These reports provides a useful tool in producing marketing trend forecasts.

11. CONVENTIONAL FINANCE VERSUS LEASE—This report provides a ratio of products sold using conventional financing versus lease.

12. REBATE REPORT—This report shows all rebates currently in the system and their expiration dates.

13. NEW OR PREVIOUS CUSTOMER—This report shows the number and percentages of new and previous customers utilizing the system within a specific period of time. The purpose of this report is to show the number of new customers being attracted to the dealership. 14. PENDING TRADES-INS—This report lists the trade-ins which may be available to the dealership on “pending” or “open” deals.

Each of the reports listed above are but examples of reports that may be generated by the system. It is anticipated that other reports will be developed for the particular needs of particular dealerships.

Although the above invention is described with reference to automobile sales, it will be appreciated by those of skill in the art that the invention could be used for selling any number of products, including, but not limited to, light trucks, medium trucks, heavy trucks, recreational vehicles, motorcycles, snowmobiles, personal watercraft, and manufactured housing. The system is not designed to be limited to the databases, files, and fields described herein, but may be sold with customized fields for use with particular products in a particular industry. These and other alternative embodiments of the invention will be easily recognizable by those of skill in the art, and the invention is not intended to be limited to the embodiment described herein. For example, although the term dealership has been used to describe the automobile sales location, the invention is not limited to sales from a dealership as any other showplaces for selling products may be used.

What is claimed is:

1. A method of matching a customer with products in a product inventory, comprising the steps of:
a. creating a product database including a plurality of product records, each of the product records including product fields containing identifying data about an associated product in the product inventory, one of the product fields including product price information;
b. creating a customer database including a plurality of customer records, each of the plurality of customer records including customer fields containing identifying data about one of a plurality of customers, the customer database further including deal fields with each deal field containing data about specific product interests for one of the plurality of customers, one of the deal fields including desired customer payment information;
c. creating a financing database including a loan rates file, the loan rates file containing rate information about loan rates offered by at least one financial institution;
d. identifying an interested customer from the plurality of customers; and
e. matching the interested customer with at least one product in the product inventory by identifying desired products having associated product fields which match the deal fields associated with the interested customer better than other product fields in the product database.

2. The method of claim 1 further comprising the step of generating a report which shows the interested customer matched with the at least one product in the product inventory.

3. The method of claim 1 further comprising the step of calculating a monthly payment for the interested customer for the at least one product in the product inventory based upon the product price information and the rate information.

4. The method of claim 2 wherein at least one of the deal fields includes a customer price factor which impacts the interested customer's monthly payment and the step of calculating the monthly payment for the interested customer for the at least one product in the in the product inventory is further based upon the customer price factor.

5. The method of claim 1 wherein the deal fields are prioritized according to the interested customer's priorities.

6. A system for matching a customer with products in a product inventory, the system comprising:
a. a product database including a plurality of product records, each of the product records including product fields containing identifying data about an associated product in the product inventory, one of the product fields including product price information;
b. a customer database including a plurality of customer records, each of the plurality of customer records including customer fields containing identifying data about one of a plurality of customers, the customer database further including deal fields with each deal field containing data about specific product interests for one of the plurality of customers, one of the deal fields including desired customer payment information;
c. a financing database including a loan rates file, the loan rates file containing rate information about loan rates offered by at least one financial institution;
d. a microprocessor operable to match an interested customer with at least one product in the product inventory by identifying desired products having associated product fields which match the deal fields associated with the interested customer better than other product fields in the product database.

7. The system of claim 6 wherein the system is further operable to generate a report which shows the interested customer matched with the at least one product in the product inventory.

8. The system of claim 6 wherein the system is further operable to calculate a monthly payment for the interested customer for the at least one product in the product inventory based upon the product price information and the rate information.

9. The system of claim 8 wherein at least one of the deal fields includes a customer price factor which impacts the interested customer's monthly payment and the step of calculating the monthly payment for the interested customer for the at least one product in the in the product inventory is further based upon the customer price factor.

10. The system of claim 6 wherein the deal fields are prioritized according to the interested customer's priorities.

11. A method of arranging a transaction between a first seller having a showplace, a second seller having a potential product for sale, and a buyer, the method comprising the steps of:
a. the first seller creating a product database, the database including a plurality of product records having product fields, one of the plurality of product records identifying the potential product for sale;
b. the first seller creating a customer database including a plurality of customer records, a first record of the plurality of customer records identifying the second seller and a second record of the customer records identifying the buyer, the customer database further including deal fields with each deal field containing data about specific product interests of the buyer;
c. associating the buyer with the potential product for sale when the product fields for the potential product for sale substantially match the deal fields containing data about the interests of the buyer;
d. showing information about the potential product for sale to the buyer to see if the buyer is interested in the potential product for sale; and
e. contacting the second seller if the buyer is interested in purchasing the potential product for sale to inform the second seller of the buyer's interest in the potential product for sale.

12. A method of offering products recently entered into a product inventory to a plurality of potential customers, the method comprising the steps of:
a. creating a customer database containing customer records associated with the plurality of potential customers, the customer database further comprising deal fields with each deal field containing data about specific product interests for each of the plurality of customers;
b. creating a product database including product records, each of the product records including product fields containing identifying data about an associated product in the product inventory;
c. receiving at least one new product and entering information about the at least one new product into one of the product records of the product database;
d. comparing the product record of the at least one new product with the deal fields in the customer database to identify potential customers that may be interested in the at least one new product;
e. providing a report of potential customers that may be interested in the at least one new product; and
f. contacting the customers potentially interested in the at least one new product to determine if they are interested in the at least one new product.
